(19) United States
(12) Patent Application Publication
(10) Pub. No.: US 2024/0305241 A1
(43) Pub. Date: Sep. 12, 2024

(54) INTERLOCKING SOLAR PANEL ARRAY SYSTEM

(71) Applicants: Jakob von Rosen Imig, Orlando, FL (US); Joseph Warren Grant, Seattle, WA (US)

(72) Inventors: Jakob von Rosen Imig, Orlando, FL (US); Joseph Warren Grant, Seattle, WA (US)

(21) Appl. No.: 18/118,575

(22) Filed: Mar. 7, 2023

(51) Int. Cl. H02S 30/10; H02S 20/25

(52) U.S. Cl. CPC H02S 30/10; H02S 20/25

(57) ABSTRACT

A solar panel construction for use in a weatherized interlocking solar panel array system, and a solar panel installation kit for installing frameless solar panels onto a battened roof or support structure, are disclosed. The solar panel array system comprises at least two rows and two columns of solar panel constructions (i.e., solar panel constructions arranged in a side-by-side fashion) interconnected together and installed on a roof or support structure, wherein the rows of solar panel constructions sealingly overlap one another (by means of a flexible rubber or elastomeric strip fitted into the upper tracks of the constructions) and the columns of solar panel constructions interconnect with one another (by means of opposing forward and rearward extending side track fins, which fins are spaced apart and parallelly nest/fit together to form an elongated water trap between adjacent panels). The solar panel installation kit comprises two specialized tracks and two brackets.

### TECHNICAL FIELD

The present invention relates generally to solar panel systems, and more particularly, to methods and structures for installing solar panels on a roof or support structure as an integrated modular array.

### BACKGROUND OF THE INVENTION

A photovoltaic (PV) cell, also commonly called a solar cell, is a nonmechanical solid-state device that converts sunlight (via the photoelectric effect) directly into electricity. A solar panel is an assembly of photovoltaic cells arranged on a substrate. Commercially available solar panels are generally made up of several discrete layers, including a top sheet layer of tempered glass, a middle photovoltaic layer consisting of solar cells, and a bottom sheet layer of a blackened rigid support material. Solar panels are conventionally manufactured in rectangular shapes of different sizes. However, and because of industry-wide standardization, solar panels in today's marketplace are generally manufactured in three standard sizes; namely, (1) a 60-cell solar panel (structured as a 6 x 10 grid that typically measures 39″(W)×66″(L)×1.3″-1.6″(D)), (2) a 72-cell solar panel (structured as a 6×12 grid that typically measures 39″(W)×77″(L)×1.3″-1.6″(D)), and (3) a 96-cell solar panel (structured as an 8 x12 grid that typically measures 41.5″(W)×62.6″(L)×1.4″(D)).

Depending on their size, solar panels generally produce between 250 watts to 400 watts (or more) of power. In order to generate greater amounts of power, multiple solar panels are generally positioned side-by-side (to form an array consisting of tightly spaced rows and columns of solar panels) and electrically connected together. For residential and commercial buildings going solar (i.e., contemplating installing a solar panel system), the size and geometry of the underlying roof or support structure dictates the maximum number of solar panels that can be installed.

Most solar panels are manufactured with a peripheral aluminum support frame (and are commonly referred to as “framed” solar panels). In contrast, more recently developed frameless solar panels (also known as “glass-on-glass” modules) are an alternative type of solar panel that because of their aesthetics and lower cost are gaining popularity in the marketplace. In frameless solar panels, the solar cells are positioned between two sheets of high-strength glass and the resulting laminate structure by itself provides sufficient strength and structural support for field use. Because there is no outer aluminum framing, frameless solar panels are generally less expensive as compared to conventional framed solar panels of the same size.

Although solar panel installation technology has advanced over the years, there is still a need in the art for new and improved solar panel arrays and related installation systems, structures, and methods. In particular, there is a need in the art for easy-to-install solar panel installation systems that weatherizes and/or envelopes an entire roof or support structure, as well as to related methods. The present invention fulfills these needs and provides for further related advantages.

### SUMMARY OF THE INVENTION

In brief, the present invention (in one embodiment) is directed to a solar panel construction for use in a weatherized interlocking solar panel array system, and (in another embodiment) to a solar panel installation kit (made up of several components) for installing frameless solar panels onto a battened roof or support structure. More specifically, the solar panel array of the present invention comprises at least two rows and two columns of solar panel constructions (i.e., solar panel constructions arranged in a side-by-side fashion) interconnected together and installed on a battened roof or support structure, wherein the rows of solar panel constructions sealingly overlap one another in a shingle-like fashion (by means of flexible rubber or elastomeric sealing strips fitted into the upper tracks) and the columns of solar panel constructions interconnect with one another (by means of opposing forward and rearward extending side track fins, which fins are spaced apart and parallelly nest/fit together to form an elongated water trap between adjacent panels). The solar panel installation kit of the present invention generally includes the following four components: (1) a side track configured to sealingly attach to a side edge/portion of a frameless solar panel, and interconnect/interlock with an adjacent side track; (2) an upper track having a lengthwise sealing strip and configured to sealingly attach to an upper edge/portion of a frameless solar panel; (3) a first-row mounting bracket configured to squeeze-fit connect to both a roof batten and to the solar panel construction; and (4) a continuation-row mounting bracket configured to squeeze-fit connect to both a roof batten and to the solar panel construction.

In certain preferred embodiments, the side tracks of the present invention have/define a triple U-shaped cross-sectional profile and are configured to sealingly attach to a frameless solar panel (wherein the triple U-shaped profile is characterized as, in combination, a first outer U-shaped profile adjoined to a second inner U-shaped profile, and a third outer U-shaped profile adjoined to the second inner U-shaped profile such that the second inner U-shaped profile is sandwiched between the first and third outer U-shaped profiles, and wherein the first and second U-shaped profiles share a common side and, in combination, define a double-U shaped profile, and wherein the third outer U-shaped profile has a base in common with a side of the double U-shaped profile, and wherein the third outer U-shaped profile is in the form a flexure bracket having an inner rubber or elastomeric lining).

In contrast to the side tracks, the upper tracks of the present invention are configured to sealingly attach to an upper edge/portion of a frameless solar panel and include (i) a lengthwise sealing strip, and (ii) an elongated upper-side flange extending outwardly along an outer edge of the upper track. The sealing strip is configured to contact and seal an adjacent (higher row) overlapping (shingle-style) solar panel.

These and other aspects of the present invention will become more evident upon reference to the following detailed description and accompanying drawings. It is to be understood, however, that various changes, alterations, and substitutions may be made to the specific embodiments disclosed herein. The described and illustrated embodiments are to be considered as illustrative and not restrictive.

### BRIEF DESCRIPTION OF THE DRAWINGS

The drawings are intended to be illustrative of certain preferred and exemplary embodiments of the present invention and may not necessarily be drawn to scale. In addition, like reference numerals have been used to designate like parts and features shown throughout the several views of the drawings.

FIG. 1a is a cross-sectional profile view of a first-row panel mounting bracket in accordance with an embodiment of the invention.

FIG. 1b is a perspective view of the first-row panel mounting bracket shown in FIG. 1a.

FIG. 2a is a cross-sectional profile view of a continuation-row panel mounting bracket in accordance with an embodiment of the invention.

FIG. 2b is a perspective view of the continuation-row panel mounting bracket shown in FIG. 2a.

FIG. 3a is a cross-sectional view of a right-side track in accordance with an embodiment of the invention.

FIG. 3b is a perspective view of the right-side track shown in FIG. 3a.

FIG. 4a is a cross-sectional view of a left-side track in accordance with an embodiment of the invention (which defines the same profile as the cross-sectional view of the right-side track shown in FIG. 3a, but wherein the track is flipped/inverted).

FIG. 4b is a perspective view of the left-side track shown in FIG. 4a.

FIG. 5a is a cross-sectional profile view of an upper track that includes an outward-facing lengthwise protruding sealing strip in accordance with an embodiment of the invention.

FIG. 5b is a perspective view of the upper track shown in FIG. 5a.

FIG. 6 is a cross-sectional view of a left-side track nested/interlocked with a right-side track (thereby defining a water trap) in accordance with an embodiment of the invention.

FIG. 7a is an exploded top plan view of a single 60-cell solar panel having a left-side track, a right-side track, and an upper-track (shown space apart and disassembled from the solar panel) in accordance with an embodiment of the invention.

FIG. 7b is a perspective view of the 60-cell solar panel shown in FIG. 6a, but where the left-side track, the right-side track, and the upper-track are sealing attached to the panel.

FIG. 8 is a perspective partially exploded view of a battened roof with a plurality of 60-cell solar panels attached onto the roof along a first-row (adjacent to the roof's edge) by means of first-row panel mounting brackets and continuation-row panel mounting brackets, as well as an additional 60-cell solar panel detached and positioned above the roof (i.e., exploded view) together with first-row panel mounting brackets and continuation-row panel mounting brackets positioned away from the panel and the roof's battens (i.e., exploded view) in accordance with an embodiment of the present invention.

FIG. 9 is a cross-sectional view of a battened roof having a plurality of overlapping (shingled) solar panels in accordance with an embodiment of the present invention.

FIG. 10 is a perspective view of a roof covered in overlapping rows of solar panels in accordance with an embodiment of the present invention.

### DETAILED DESCRIPTION OF THE INVENTION

The present invention may be understood more readily by reference to the following detailed description of certain preferred and exemplary embodiments of the invention in view of the accompanying drawings. In this context, it is to be understood that the terminology used herein is for the purpose of describing specific embodiments only and is not intended to be limiting. It is to be further understood that unless specifically defined herein, the terminology used herein is to be given its conventional meaning as understood in the relevant art. Any headings used within this document are only being utilized to expedite its review by the reader, and should not be construed as limiting the claimed invention in any way. In addition, and as used within this document, the relative terms left and right, upper and lower, front and forward, and back and rearward, signify the relative positions of a rectangular solar panel conventionally mounted/installed on a roof or support structure as observed by an observer standing on the ground.

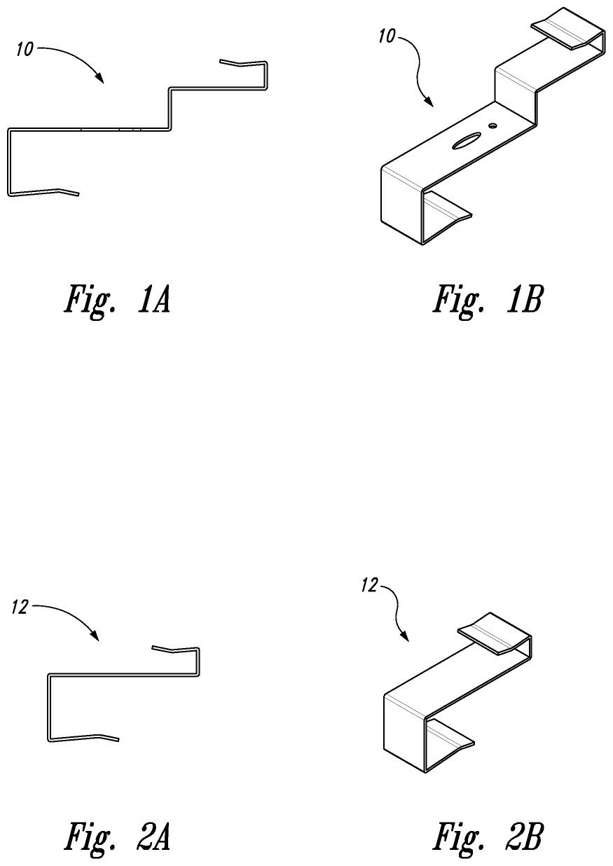

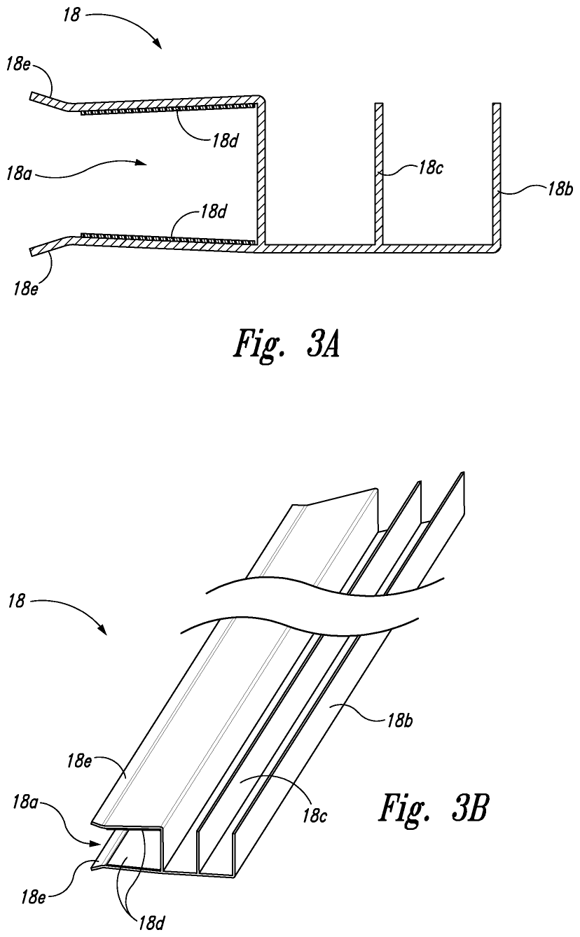

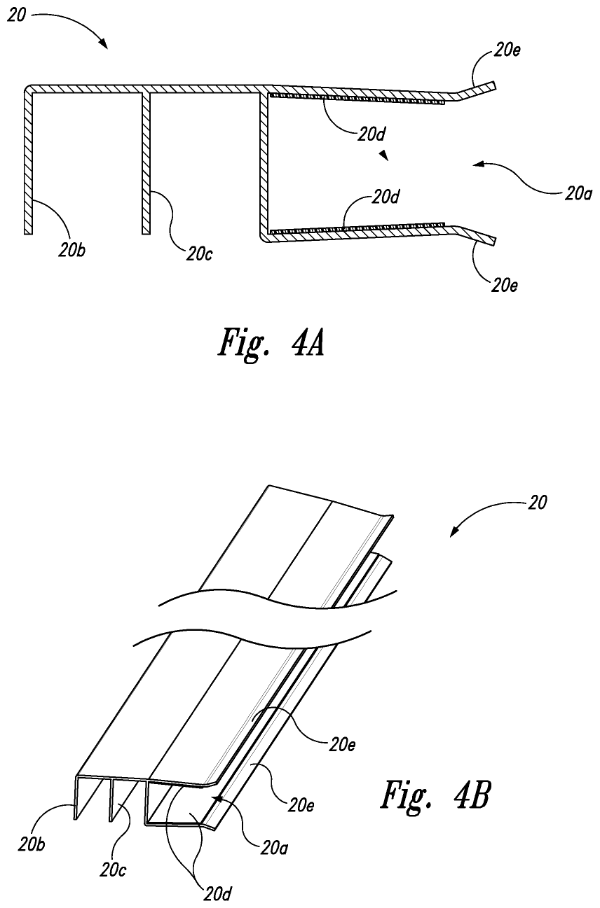

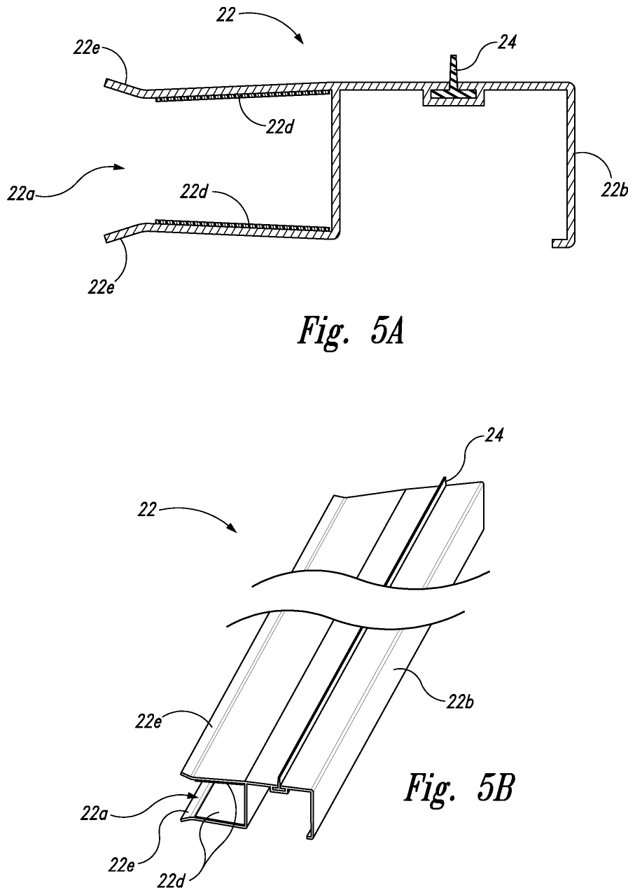

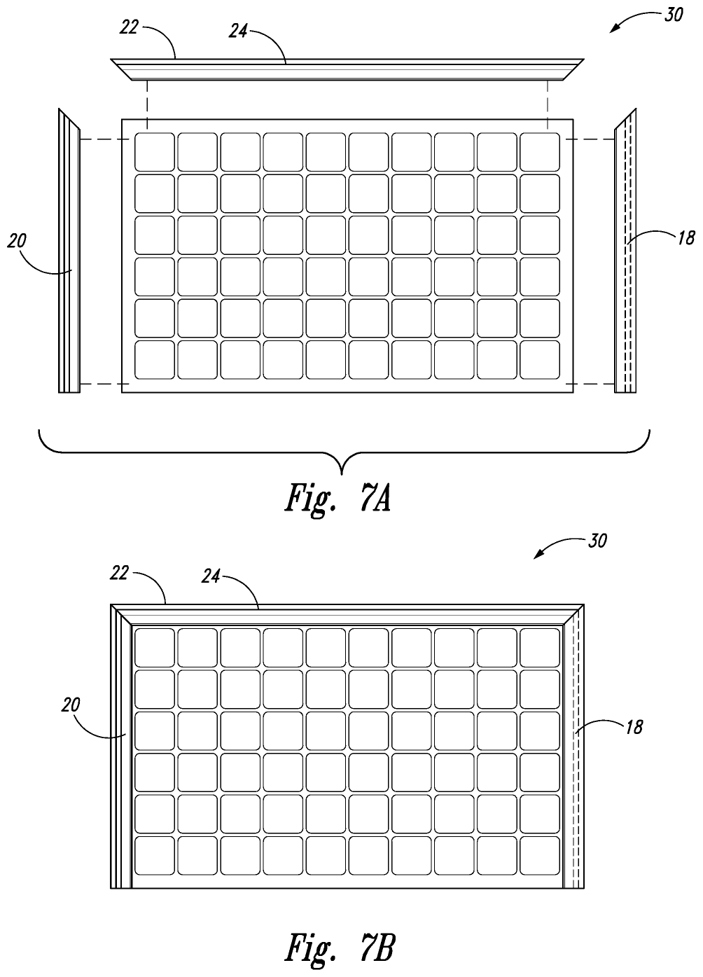

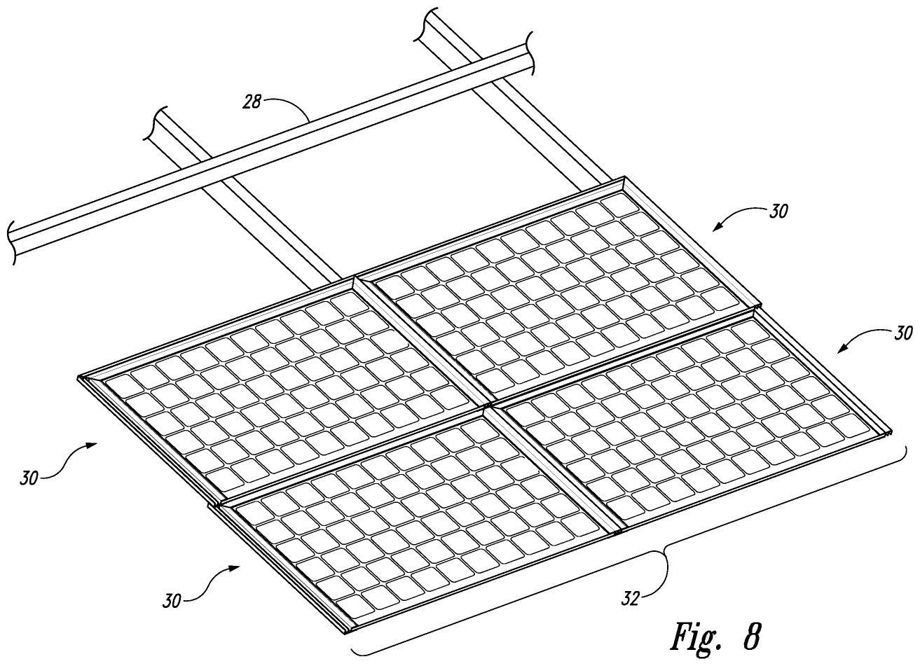

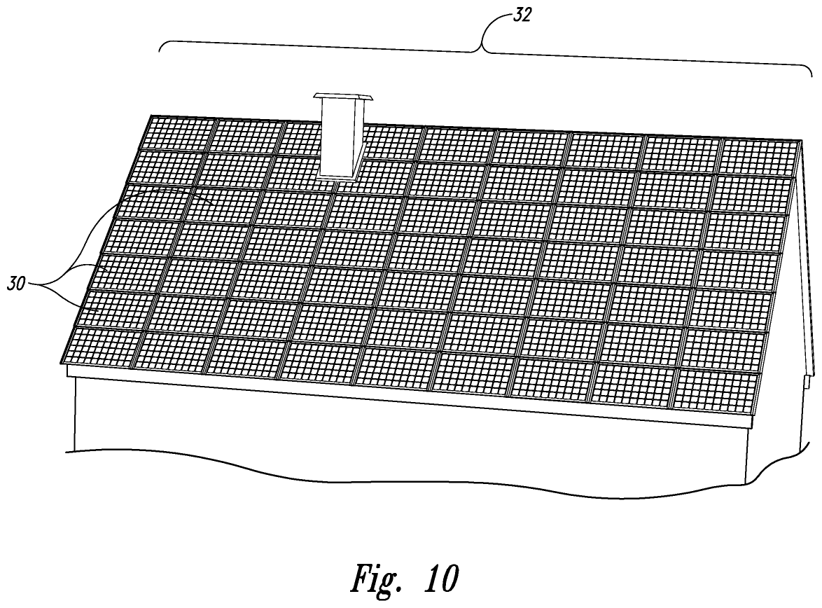

In view of the foregoing, the present invention in one embodiment (and as shown in FIGS. 7-10) is directed to a solar panel construction 30 (FIGS. 7a-b) for use in a weatherized interlocking solar panel array system 32 (FIGS. 8-10), and in another embodiment to a solar panel installation kit (made up of two types of tracks-namely, side tracks and upper tracks, and two types of brackets-namely, first-row and continuation-row brackets) for installing a plurality of frameless solar panels onto a battened roof or support structure. In this regard, the solar panel installation kit of the present invention generally includes the following four components: (1) a side track 18, 20 (best shown in FIGS. 3-4) having one side configured to sealingly attach (by means of side track flexure brackets 18a, 20a) to a frameless glass-on-glass solar panel, and interconnect/interlock with an adjacent side track; (2) an upper track 22 (best shown in FIGS. 5a-b) having a lengthwise sealing strip 24 and having one side configured to sealingly attach (by means of an upper track flexure bracket 22a) to a frameless glass-on-glass solar panel; (3) a first-row mounting bracket 10 (as best shown in FIGS. 1a-b) configured to squeeze-fit connect to both a roof batten and to a bottom edge of a frameless solar panel 30; and (4) a continuation-row mounting bracket 12 (as best shown in FIGS. 2a-b) configured to squeeze-fit connect to both a roof batten and to an upper track of a solar panel construction 30. These four components are generally sized and configured to fit conventional frameless solar panels of standardized sizes.

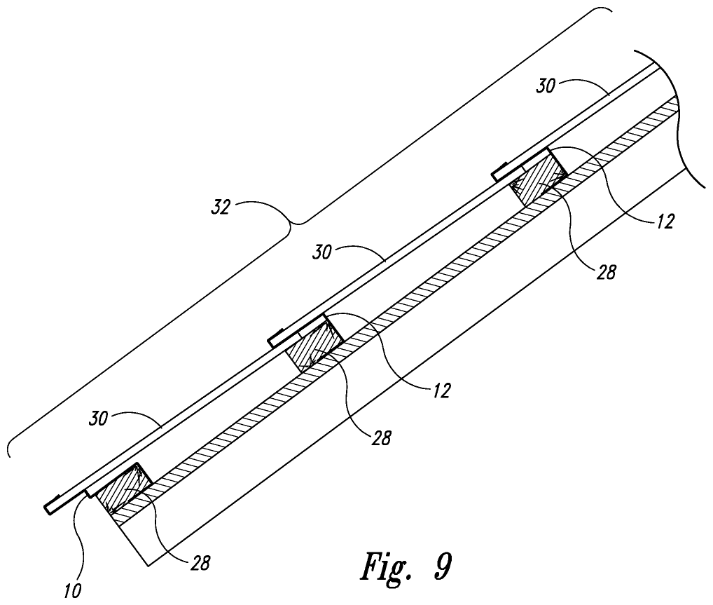

With particular reference to FIGS. 1-2 and 8-9, the present invention in an embodiment (and stated somewhat differently) is directed to a solar panel installation kit that includes: a first-row mounting bracket 10 (FIG. 1a-b) configured to squeeze-fit connect (to thereby yield a friction fit) to both a roof batten 28 and to a bottom edge of a frameless solar panel 30 (FIGS. 8-9); and, a continuation-row mounting bracket 12 (FIG. 2a-b) configured to squeeze-fit connect (to thereby yield a friction fit) to both a roof batten 28 and to an upper track 22 of a solar panel construction 30 (FIGS. 8-9). The first-row mounting bracket 10 and the continuation-row mounting bracket 12 are preferably made of a spring steel (but may be made of plastic or another metal) and have/define two distinct generally U-shaped cross-sectional squeeze-fit profiles that are different in size and spaced apart at opposing ends, but wherein the angles at the base of the U-shaped profiles are, as shown, preferably slightly less than 90 degrees (right angles) and have ends that flare outward-thereby facilitating easy squeeze-fit (to yield a friction fit) attachment to roof battens 28 at one end and exterior sides of solar panels 30 at the other end (as best shown in FIGS. 8-9). As used herein (and as understood by those skilled in the art), spring steel is a common type of steel alloy that has been processed (as by, for example, cold drawing, cold rolling, or heat treatment) to give it improved elastic properties and yield strength-spring steel is especially useful in the manufacture springs and durable parts requiring consistent and durable elastic properties. Because of its superior corrosion resistance, strength, and durability, austenitic stainless steel is a preferred material for making the squeeze-fit brackets and tracks disclosed herein.

Referring now to FIGS. 3a-b, the solar panel installation kit also includes a right-side track 18 that along one side (as shown) comprises a lengthwise first generally U-shaped flexure bracket 18a, and further comprises both (i) an elongated left-side flange 18b extending outwardly along an outer edge of the right-side track 18, and (ii) an elongated inner right-side fin 18c extending outwardly and parallelly adjacent to the right-side flange 18b. The right-side track 18 is preferably manufactured via an extrusion process (of either a resilient flexible plastic such as, for example, a polyurethane, or an elastic and corrosion-resistant metals such as, for example, a spring steel) and may be cut to length/fit at the factory or in the field. In addition, the first generally U-shaped flexure bracket 18a includes an inner rubber or elastomeric liner 18d (that creates a seal with a side edge/portion of a glass-on-glass solar panel) and has outward flaring ends 18e (that facilitates the squeeze-fit attachment to the solar panel). In some embodiments, the inner liner 18d may be a compressible foam material.

Referring now to FIGS. 4a-b, the solar panel installation kit still further includes a left-side track 20 that comprises a lengthwise second generally U-shaped flexure bracket 20a, and further comprises both (i) an elongated left-side flange 20b extending outwardly along an outer edge of the left-side track, and (ii) an elongated inner left-side fin 20c extending outwardly and parallelly adjacent to the left-side flange 20b. In addition, and just like the first flexure bracket 18a of the right-side track 18, the second generally U-shaped flexure bracket 20a similarly includes an inner rubber or elastomeric liner 20d (that creates a seal with a side edge/portion of a glass-on-glass solar panel) and has outward flaring ends 20e (that facilitates the squeeze-fit attachment to the solar panel). In some embodiments, the inner liner 20d may be a compressible foam material.

Preferably, the right-side track 18 and the left-side track 20 have the same cross-sectional profile (noting that the profile of the left-side track 20 is generally the same as a flipped/inverted profile of the right-side track 18) and are manufactured in the same way. In other words, the right-hand track 18 and the left-hand track 20 preferably have the same cross-sectional profile with the differences between the two tracks being merely the direction of the angle of the cut (when the track is cut to fit the two opposing sides of a solar panel).

Referring now to FIGS. 5a-b, the solar panel installation kit still further includes an upper track 22 that comprises a lengthwise third generally U-shaped flexure bracket 22a and an outward-facing lengthwise sealing strip 24. As shown, the upper track 22 has an elongated upper-side flange 22b extending outwardly along an outer edge and opposite from the third flexure bracket 22a. In addition, the third flexure bracket 22a preferably includes an inner rubber or elastomeric third liner 22d (that contacts a solar panel when the solar panel is positioned/installed therebetween) and has outward flaring ends 22e (that facilitates the squeeze-fit attachment to the solar panel). In some embodiments, the inner liner 22d may be a compressible foam material.

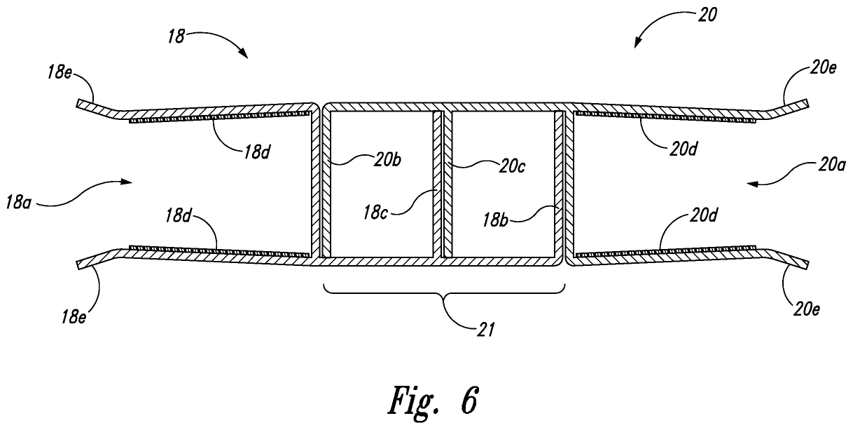

Referring now to FIG. 6, an important feature of the solar panel array system 32 of the present invention is the way adjacent solar panels interconnect with each other such that the underlying roof or support structure is shielded (i.e., weatherized) from rain water. As shown, a left-side track 18 nests/interlocks with a right-side track 20 thereby defining a water trap 21, and interconnect adjacent solar panels with each other (by means of the opposing forward and rearward extending side track fins 18c, 20c, which fins are spaced apart and parallelly nest together to form an elongated water trap 21 between adjacent panels). The water trap 21 traps and diverts rain water such that the underlying roof or support structure surface stays dry.

Referring now to FIGS. 7a-b, the present invention in another embodiment is directed to a solar panel construction 30 for use in a weatherized interlocking solar panel array system 32 (as shown in FIGS. 8-10). The solar panel construction comprises a rectangular solar panel 30 that has a left-side track 18, a right-side track 20, and an upper track 22-which tracks are sealingly squeeze-fit attached lengthwise to the edges/side portions of the solar panel 30 by means of first, second, and third generally U-shaped flexure bracket 18a, 20a, 22a. In other words, the left-side track 18, the right-side track 20, and the upper track 22 are friction fitted or adhered to the respective left, right, and upper-sides of the solar panel 30 by means of the inwardly facing the first, second, and third generally U-shaped flexure brackets 18a, 20a, 22a so as to sealingly retain the solar panel 30 therebetween. Preferably, the first, second, and third flexure brackets 18a, 20a, 22a include inner rubber or elastomeric first liners 18d, 20d, 22d (layers) that contacts and seals the solar panel 30 therebetween.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

1. A solar panel construction for use in a weatherized interlocking solar panel array system, comprising:
a rectangular solar panel;
a left-side track comprising a lengthwise first generally U-shaped single piece flexure bracket, wherein the left-side track is friction fitted to the exterior left-side of the solar panel by means of the inwardly facing first generally U-shaped flexure bracket so as to sealingly retain the solar panel therebetween, wherein the first flexure bracket includes an inner rubber or elastomeric first liner that contacts the solar panel therebetween, and wherein the left-side track further comprises (i) an elongated left-side flange extending outwardly along an outer edge of the left-side track, and (ii) an elongated inner left-side fin extending outwardly and parallelly adjacent to the left-side flange;
a right-side track comprising a lengthwise second generally U-shaped single piece flexure bracket, wherein the right-side track is friction fitted to the exterior right-side of the solar panel by means of the inwardly facing second generally U-shaped flexure bracket so as to sealingly retain the solar panel therebetween, wherein the second flexure bracket includes an inner rubber or elastomeric second liner that contacts the solar panel therebetween, and wherein the right-side track further comprises (i) an elongated right-side flange extending outwardly along an outer edge of the right-side track, and (ii) an elongated inner right-side fin extending outwardly and parallelly adjacent to the right-side flange;
an upper single piece track comprising a lengthwise third generally U-shaped flexure bracket, wherein the upper track is friction fitted to the exterior upper-side of the solar panel by means of the inwardly facing third generally U-shaped flexure bracket so as to sealingly retain the solar panel therebetween, wherein the third flexure bracket includes an inner rubber or elastomeric third liner that contacts the solar panel therebetween, and wherein the upper track further comprises (i) a lengthwise sealing strip, and (ii) an elongated upper-side flange extending outwardly along an outer edge of the upper track.

2. The solar panel construction of claim 1 wherein the left-side track and the right-side track are made via an extrusion process and have cross-sectional profiles that are substantially the same.

3. The solar panel construction of claim 2 wherein the first, second, and third generally U-shaped flexure brackets have at their respective ends pairs of opposing outwardly flaring respective first, second, and third bracket tips.

4. The solar panel construction of claim 3 wherein the left-side flange and the right-hand flange are perpendicular to the major planar surfaces of the solar panel.

5. The solar panel construction of claim 4 wherein the left-side flange, the left-side fin, the right-side flange, and the right-side fin all have the same, or about the same, dimensions of length, height, and width.

6. The solar panel construction of claim 4 wherein the left-side track, the right-side track, and the upper track are made of a plastic or a spring steel.

7. The solar panel construction of claim 5 wherein the plastic is a polyurethane and the spring steel is an austenitic stainless steel.

8. A weatherized interlocking solar panel array system, comprising:
a plurality of rectangular solar panels arranged in a side-by-side fashion on a roof or support structure, wherein each solar panel comprises:
a left-side track comprising a lengthwise first generally U-shaped single piece flexure bracket, wherein the left-side track is friction fitted to the exterior left-side of the solar panel by means of the inwardly facing first generally U-shaped flexure bracket so as to sealingly retain the solar panel therebetween, wherein the first flexure bracket includes an inner rubber or elastomeric first liner that contacts the solar panel therebetween, and wherein the left-side track further comprises (i) an elongated left-side flange extending outwardly along an outer edge of the left-side track, and (ii) an elongated inner left-side fin extending outwardly and parallelly adjacent to the left-side flange;
a right-side track comprising a lengthwise second generally U-shaped single piece flexure bracket, wherein the right-side track is friction fitted to the exterior right-side of the solar panel by means of the inwardly facing second generally U-shaped flexure bracket so as to sealingly retain the solar panel therebetween, wherein the second flexure bracket includes an inner rubber or elastomeric second liner that contacts the solar panel therebetween, and wherein the right-side track further comprises (i) an elongated right-side flange extending outwardly along an outer edge of the right-side track, and (ii) an elongated inner right-side fin extending outwardly and parallelly adjacent to the right-side flange;
an upper track comprising a lengthwise third generally U-shaped single piece flexure bracket, wherein the upper track is friction fitted to the exterior upper-side of the solar panel by means of the inwardly facing third generally U-shaped flexure bracket so as to sealingly retain the solar panel therebetween, wherein the third flexure bracket includes an inner rubber or elastomeric third liner that contacts the solar panel therebetween, and wherein the upper track further comprises (i) a lengthwise sealing strip, and (ii) an elongated upper-side flange extending outwardly along an outer edge of the upper track;
whereby the plurality of solar panels are arranged to form at least two rows and two columns of solar panels interconnected together, wherein the rows of solar panels sealingly overlap one another by means of a flexible rubber or elastomeric upper track strip fitted to the upper tracks, and wherein the columns of solar panels interconnect with one another by means of opposing forward and rearward extending side track fins, which fins are spaced apart and parallelly nest together to form an elongated water trap between adjacent panels.

9-10. (canceled)
